(19) United States
(12) Patent Application Publication
(10) Pub. No.: US 2015/0058429 A1
(43) Pub. Date: Feb. 26, 2015

(54) MESSAGE TRACKING

(71) Applicant: Answerbook, Inc., San Francisco, CA (US)

(72) Inventors: Li Liu, San Francisco, CA (US); Christopher Nguyen, San Francisco, CA (US)

(21) Appl. No.: 14/466,318

(22) Filed: Aug. 22, 2014

Related U.S. Application Data
(60) Provisional application No. 61/869,812, filed on Aug. 26, 2013.
(60) Provisional application No. 61/869,802, filed on Aug. 26, 2013.

(51) Int. Cl. H04L 12/58; H04L 29/06

(52) U.S. Cl. CPC H04L 51/34; H04L 67/42
USPC 709/206

(57) ABSTRACT

Methods and systems for tracking emails are disclosed. Examples include determining the duration of time an email is open, determining whether to initiate or continue a connection with a tracking element, and determining which particular recipient(s) opened an email sent to multiple recipients.

### CROSS-REFERENCE TO RELATED APPLICATIONS

This application claims priority to co-pending U.S. provisional patent application Ser. No. 61/869,812, titled “Determining View Time by Timing a Tracking Media Element in Email,” filed on Aug. 26, 2013, and U.S. provisional patent application Ser. No. 61/869,802, titled “Determine Who Read Your Email When Sending to Multiple Recipients,” filed on Aug. 26, 2013, the disclosures of both of which are herein incorporated by reference in their entireties.

### TECHNICAL FIELD

The present disclosure relates generally to the field of electronic message tracking, and in particular to systems and methods for determining the amount of time a particular electronic mail (“email”) is open and identifying specific recipients that open an email sent to multiple recipients.

### BACKGROUND

Email communication has become an integral and widely used form of professional and social communication. In some instances it can be useful to determine whether an email recipient has received and/or opened an email sent to such recipient. To this end, some prior art systems allow the sender of an email to a single recipient to determine whether the recipient has opened the email. Such information is typically displayed as a notification or status update by the sender's email client. In a similar fashion, some prior art systems allow the sender of an email to multiple recipients to determine whether at least one of the recipients has opened the email; however, the sender cannot determine which particular recipient opened the email.

### SUMMARY

In general, one aspect of the subject matter disclosed in this specification can be embodied in methods that include the actions of sending an email containing a tracking element to a recipient, establishing a connection with the tracking element upon the email being opened by the recipient, determining a time when the connection ends, and calculating a duration of the connection. Other embodiments of this aspect include corresponding systems, apparatus, and computer programs.

These and other aspects can optionally include one or more of the following features. The method can include communicating the duration of the connection to a sender of the email. The method can include embedding the tracking element within the email prior to sending the email to the recipient. In some instances, the method can include timing a length of the connection, where calculating a duration of the connection comprises referencing a result of the timing. In other instances, the method can include recording a time when the connection is opened, where calculating a duration of the connection comprises subtracting the time when the connection is opened from the time when the connection ends. The tracking element can include at least one of an image, an audio element, and a video element.

In general, one aspect of the subject matter disclosed in this specification can be embodied in methods that include the actions of sending an email containing a tracking element to a recipient, and detecting that an aspect of the recipient's environment may cause an undesirable side effect when used with the tracking element. Other embodiments of this aspect include corresponding systems, apparatus, and computer programs.

These and other aspects can optionally include one or more of the following features. In some instances, the method can include, based on the detecting, determining to not initiate a connection with the tracking element. In other instances, the method can include aborting an existing connection with the tracking element. An aspect of the recipient's environment that may cause an undesirable side effect can include at least one of an email client, a cellular data network, an email service provider, a mobile device, a computing device, and a software.

In general, one aspect of the subject matter disclosed in this specification can be embodied in methods that include the actions of receiving an email addressed to multiple recipients, generating a separate envelope for each recipient, attaching a unique tracking element to each envelope, and sending the separate envelopes each comprising a unique tracking element to the recipients. Other embodiments of this aspect include corresponding systems, apparatus, and computer programs.

These and other aspects can optionally include one or more of the following features. The method can include determining which recipients have opened the email by establishing separate connections with the unique tracking elements, and communicating which recipients have opened the email to a sender of the email. The tracking element can include at least one of an image, an audio element, and a video element.

### BRIEF DESCRIPTION OF THE DRAWINGS

FIG. 1 illustrates an example system for performing implementations of the present disclosure.

FIG. 2 is a flow chart showing an example method for determining the duration of time that an email is open.

FIG. 3 is a flow chart showing an example method for determining whether to initiate and/or continue a connection with a tracking element.

FIG. 4 is a flow chart showing an example method for determining which recipient(s) opened an email sent to multiple recipients.

### DETAILED DESCRIPTION

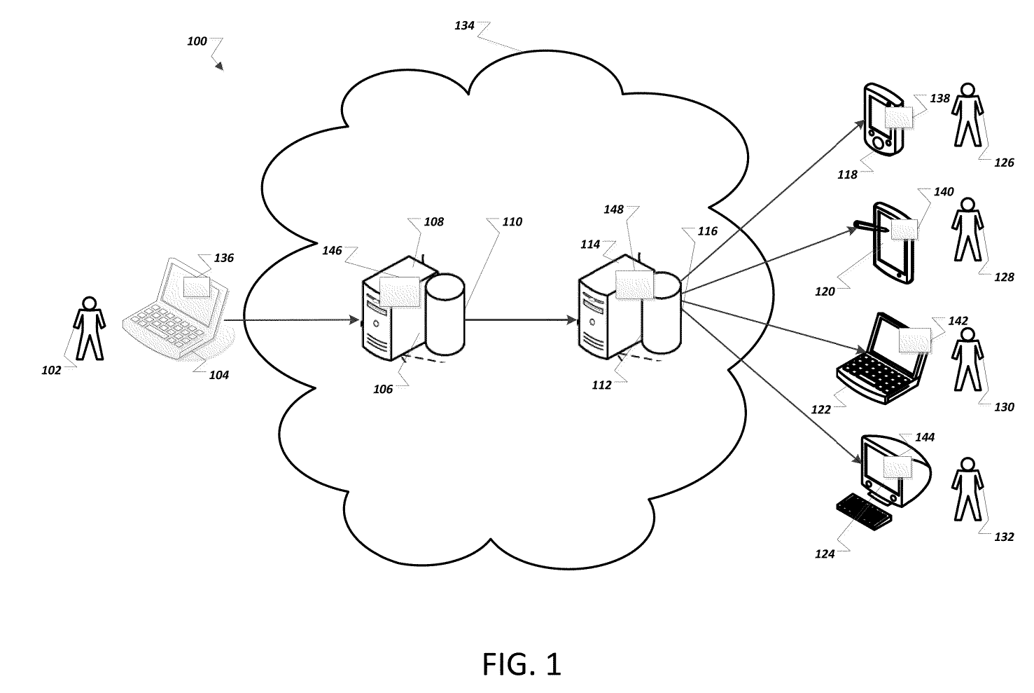

Implementations of this disclosure relate to improved systems and methods for tracking electronic messages. In particular, in some implementations, the disclosure relates to systems and methods for determining the amount of time that a particular email was open. In other implementations, the disclosure relates to systems and methods for determining which particular recipient(s) opened an email sent to multiple recipients. Implementations of the subject matter described herein can, in some instances, be embodied in a system. FIG. 1 is a block diagram of an example system on which aspects of the disclosure can be implemented. System 100 includes a sending client device 104 that can allow sender 102 to engage an email client 136 (e.g., Microsoft Outlook, Novell Groupwise, etc). Sender 102 can use email client 136 to compose, send, and/or receive emails. Email client 136 can also receive information regarding sent emails (e.g., whether such emails have been opened). Sending client device 104 and/or email client 136 can transfer emails to sending server 106, which can include at least one computing device 108 and memory 110. Following receipt of an email, sending server system 106 can transfer the email to receiving server 112, which can include at least one computing device 114 and memory 116. Receiving server 112 can then transfer the email to a receiving client device 118, 120, 122, 124 which can have recipients 126, 128, 130, 132 associated therewith. Recipients 126, 128, 130, 132 can access a received email through email clients 138, 140, 142, 144 associated with receiving client devices 118, 120, 122, 124. In some implementations, the email can be sent to a single recipient. In other implementations, the email can be sent to multiple recipients. Example system 100 can also include additional client devices and servers which are not shown.

The above-described transfers can occur over network 134. Network 134 can include a large computer network, examples of which include a local area network (LAN), wide area network (WAN), the Internet, a cellular network, or a combination thereof connecting a number of mobile client devices, fixed client devices, and server systems. The network(s) included in network 134 can provide for communications under various modes or protocols. Although this disclosure will primarily refer to Simple Mail Transfer Protocol (SMTP), other protocols can also be employed. Examples of such protocols include Transmission Control Protocol/Internet Protocol (TCP/IP), Global System for Mobile communication (GSM), Short Electronic message Service (SMS), Enhanced Messaging Service (EMS), or Multimedia Messaging Service (MMS) messaging, Ethernet, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication can occur through a radio-frequency transceiver. In addition, short-range communication can occur, e.g., using a BLUETOOTH, WiFi, or other such transceiver system. In example system 100, sending client device 104 and receiving client device 122 are illustrated as laptop-type computing devices, receiving client devices 118, 120 are illustrated as mobile computing devices, and receiving client device 124 is illustrated as a desktop-type computing device. It is noted, however, that client devices 104, 118, 120, 122, and 124 can include, e.g., a desktop computer, a laptop computer, a handheld computer, a television with one or more processors embedded therein and/or coupled thereto, a tablet computing device, a personal digital assistant (PDA), a cellular telephone, a network appliance, a camera, a smart phone, a tablet computer, a smart watch, an enhanced general packet radio service (EGPRS) mobile phone, a media player, a navigation device, an electronic messaging device, a game console, or a combination of two or more of these data processing devices or other appropriate data processing devices. In some implementations, a client device can be included as part of a motor vehicle (e.g., an automobile).

Email client 136 can be associated with a sending email module 146 located on sending server 106, and email clients 138, 140, 142, and 144 can be associated with a receiving email module 148 located on receiving server 112. The email clients 136, 138, 140, 142, and 144 can be implemented as software, hardware or a combination of software and hardware that is executed on a processing apparatus, such as one or more computing devices. Similarly, the sending email module 146 and receiving email module 148 can be implemented as software, hardware or a combination of software and hardware that is executed on a processing apparatus, such as one or more computing devices.

Examples of various aspects and implementations of this disclosure are discussed in more detail below.

### Determining Amount of Time a Particular Email is Open

In some situations it may be desirable to know the duration of time the recipient of an email had the email open. Such knowledge can allow the sender of the email to make various inferences regarding the level of engagement the recipient had with the email. For example, if a sender sends an email containing multiple paragraphs of text, and the recipient only had the email open for one second, the sender can infer that the recipient did not read the email in its entirety. Similarly, if the recipient has the email open for 10 minutes, the recipient can infer that recipient read the entire email, and potentially gave some thought to its contents. Although such inferences may be incorrect, it is still valuable for an email sender to have the knowledge required to make such inferences.

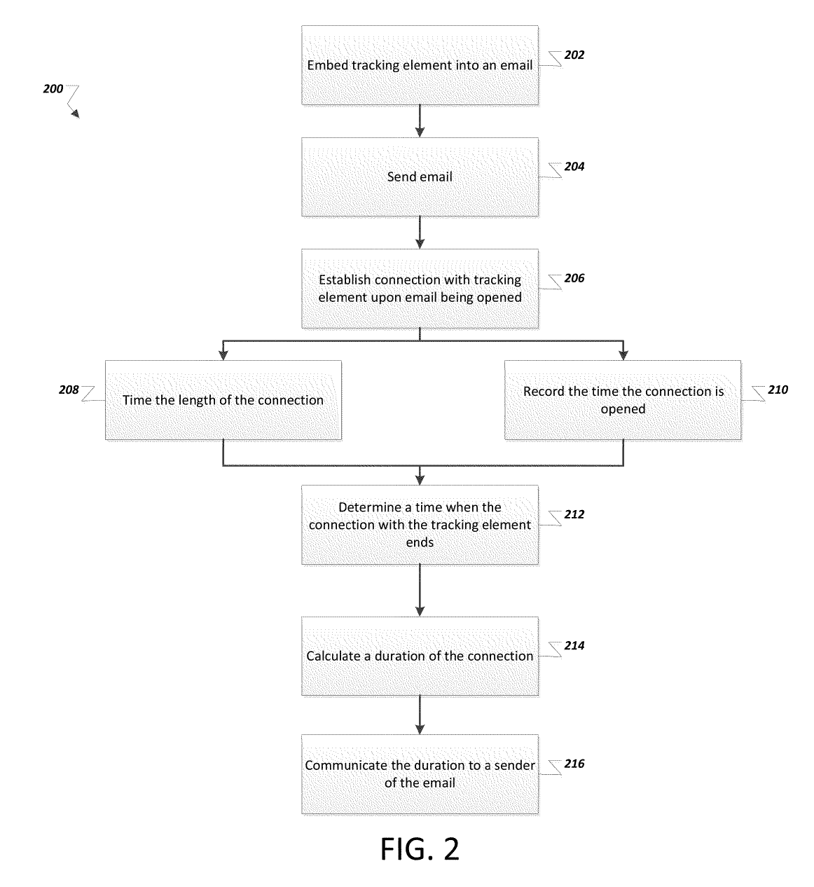

An implementation of the present disclosure allows an email sender to determine the duration of time the recipient of an email has the email open. FIG. 2 is a flow chart showing an example method 200 for tracking the view time of a particular email. In some instances, some or all of the steps of this method may be performed by sending server 106. In other instances, the steps may be performed by other devices, for example, components of client device 104. The method can include embedding 202 a tracking element into an email. In general, the tracking element can include any type of media, for example, an image, an audio element, and/or a video element. In some cases the tracking element can reference an internet URL (i.e., is not an attached element). In some cases, the tracking element is a javascript code embedded in the body of the email that gets invoked when the image, audio element, and/or video element is displayed. In cases in which the tracking element is an image, the image can be an “image pixel” of a miniscule size such that it cannot be seen by the email recipient. Similarly, other types of tracking elements may be invisible to the email recipient as well. In certain applications, multiple tracking elements may be embedded within an email to enhance detection. The method can include sending 204 the email. In some instances the email may be sent to receiving server 114 and ultimately to a receiving client device 118, 120, 122, 124, where it can be opened by a recipient 126, 128, 130, 132 using a receiving email client 138, 140, 142, 144. Once the email is opened by a recipient, the method can include establishing 206 a connection with the tracking element. Such a connection can be initiated by the receiving client device and may include the embedded tracking element connecting to the source (e.g., sending server 106) of its content (e.g., an image, audio element, video element). In general, the communication between the tracking element and its source (e.g., sending server 106) can occur using any protocol, for example, Transmission Control Protocol (TCP) or User Datagram Protocol (UDP). In some instances, a tracking element can contain a unique identifier (e.g., a Globally Unique Identifier (GUID)), as discussed in more detail below. In such instances, the unique identifiers can allow sending server 106 (or other similar apparatus) to determine the identity of the receiving client devices with which it establishes a connection. In some instances, after the connection is established, the method can include timing 208 the length of the connection, for example, by running a clock. In other instances, instead of actively timing the length of the connection, the method may include recording 210 a time when the connection is opened. The method can then include determining 212 a time when the connection with the tracking element ends. In some instances, the connection ends when the recipient's mail client aborts the connection, e.g., when the recipient closes the email. In other instances, the connection ends when sending server 106 (or similar apparatus) determines that recipient is likely not engaged with the email, for example, if the email has been moved to the background and/or minimized in the user interface of the receiving client device, if the user loads another tracking element while the first one is still active (potentially indicating that recipient has opened another email), if the recipient hits reply to the email, and/or if the receiving client device has remained idle for a predetermined period of time (e.g., between 60 and 140 seconds). Once the connection has ended, the method can include calculating 214 a duration of the connection. In instances in which the connection is actively timed (e.g., using a clock), the calculating step can include referencing the result of such timing. In instances that do not include active timing, but that record the time the connection is opened, the calculating step can include subtracting the opening time from the ending time. After the duration of the connection has been calculated, the method can include communicating 216 the duration to the sender of the email. Such communication may include, for example, providing a notification displayed on sender's email client 136.

In certain circumstances, a recipient's environment may cause undesirable side effects when used in conjunction with a tracking element. As one example, some receiving email clients may crash if a tracking element takes a certain amount of time to load. As another example, some receiving email clients may not load the most recent email in a message thread if the most recent message contains a tracking element. In such circumstances, it can be advantageous to sacrifice receiving the information provided by the tracking element in order to avoid such side effects. An aspect of the present disclosure relates to a method for avoiding undesirable side effects in these circumstances.

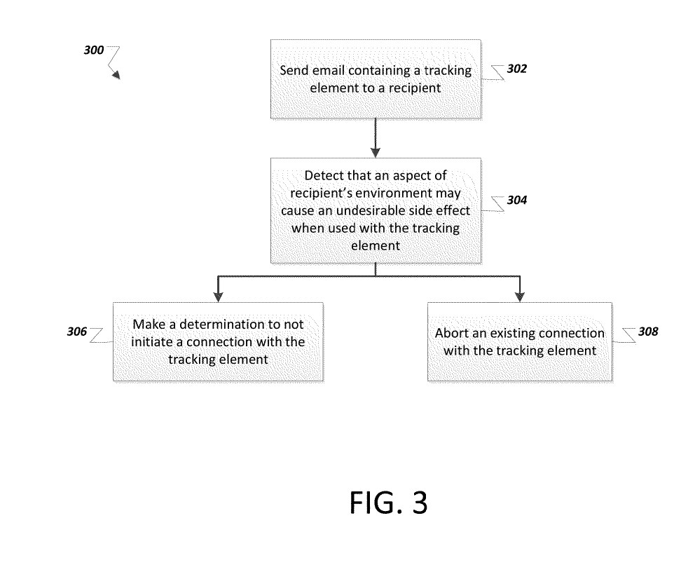

FIG. 3 is a flow chart showing an example method 300 for determining whether to initiate and/or continue a connection with a tracking element. In some instances, some or all of the steps of this method may be performed by sending server 106. In other instances, the steps may be performed by other devices, for example, components of client device 104. The method can include sending 302 an email containing an embedded tracking element to a recipient in the same manner as described above. The method can then include detecting 304 that an aspect of recipient's environment may cause an undesirable side effect with the tracking element. Example aspects of the recipient's environment that can cause such side effects include: recipient's email client, recipient's cellular data network, recipient's email service provider, recipient's mobile device, recipient's computing device, and/or a particular software used by recipient. In some instances, a determination that recipient's environment may cause undesirable side effects is made prior to a connection being initiated between the tracking element and the source of its content (e.g., sending server 106). In such instances, the method can include making 306 a determination to not initiate a connection with the tracking element. In other instances, a determination that recipient's environment may cause undesirable side effects is made after the tracking element is already connected to the source of its content (e.g., sending server 106). In such instances, the method can include aborting 308 the existing connection with the tracking element. Alternatively, in situations in which the undesirable side effect detected is that the receiving email client may not load the most recent email in a message thread if the most recent message contains a tracking element, rather than making a determination to not initiate and/or abort a connection with the tracking element, sending server 106 can establish a connection with an older message in the message thread.

Identifying Specific Recipients that Open an Email Sent to Multiple Recipients

Emails are often sent to multiple recipients. In some circumstances the purpose of sending a particular email to one recipient is different than the purpose of sending the email to another recipient. For example, an email header may list certain individuals in the “To” line and other individuals in the “cc” line. The email may be primarily addressed to recipients listed in the “To” line, while recipients listed in the “cc” line receive the email as a courtesy or to keep such individuals informed, for example. Although for simplicity this disclosure will primarily refer to the “To” and “cc” lines, similar methods can also be employed for recipients listed in the “bcc” line. Recipients listed in the “bcc” line receive the email, but their email addresses do not appear in the header of the email sent to the other email recipients.

Upon sending an email to multiple recipients, it can be desirable to know which particular recipient opened an email. As one non-limiting example, imagine a situation in which an email sender sends an important time sensitive email to an external party and copies the sender's entire internal team. In this situation, using prior art systems, it can be very difficult for the sender to determine whether the external party has opened the email or not. Although the prior art system may inform the sender that at least one of the recipients has opened the email, the sender is unable to discern whether the party that opened the email is the external party listed in the “To” line, or one of the members of sender's internal team listed in the “cc” line.

An aspect of the present disclosure allows the sender of an email to multiple recipients to determine which particular recipient(s) have opened the email. In order to describe this aspect, it is useful to provide a brief description of how some prior art systems track multiple recipient emails. In such prior art systems, a multiple recipient email is often sent from an email client to a server using SMTP protocol. Although the remainder of this discussion will refer to, and give examples using, SMTP protocol, an analogous description could be given using other mail protocols as well. In order to transfer the multiple recipient email from the email client to the server, a series of commands (defined by the protocol) are exchanged between the client and the server. For example, various commands can be used to: open a connection between the email client and the server, identify the email client domain name, inform the server of a return address to send return emails to, inform the server of the recipients of the email, inform the server of the body (i.e., message) of the email, and close the connection with the server. Other commands are also possible. In some cases, the server uses the information communicated during this exchange to create a package of information that includes the addresses for the email recipients, as well as the email's contents; this package is often referred to as an “envelope.”

Under SMTP protocol, the recipients of the email are communicated using the RCPT command. In some prior art systems, an email client will automatically send an RCPT command for each recipient listed in the header of an email. For example, if an email includes two recipients in the “To” line: bob@abc.com and joe@abc.com; and one recipient in the “cc” line: alice@abc.com, existing email clients will automatically execute an RCPT command for each recipient. Upon receipt of an RCPT command, the server will send an acknowledgement of receipt back to the email client and add the recipient's address to the envelope. In addition to communicating the recipients of an email, existing email clients will also communicate the content of the email, which includes both a header (e.g., listing the recipients) and a body (e.g., the message). In the below example, such content is communicated using the command “DATA.” In some cases, the server also adds the email content to the envelope before sending to recipients. An example exchange between an existing email client and server as described above can be seen below; “C” represents “email client” and “S” represents “server.”

C: RCPT TO: bob@abc.com

S: Ok

C: RCPT TO: joe@abc.com

S: Ok

C: RCPT TO: alice@abc.com

S: Ok

C: DATA

To: bob@abc.com; joe@abc.com

cc: alice@abc.com

Date: Tue, 8 Aug. 2014

Subject: Message

Hello Bob and Joe,

This is an example message.

Best,

Sender

S: Ok

Note from the above example that in such prior art systems the same message is sent to all recipients. The RCPT command is automatically executed for each recipient, and in fact, does not even differentiate between recipients in the “To” line and recipients in the “cc” line, it simply informs the server to send the email to all recipients. Email recipients can determine who is in the “To” line and who is in the “cc” line by the message header communicated using the DATA command (or similar command with other protocols). Because the same envelope is sent to all recipients, in instances in which a tracking element is included in the envelope, the same tracking element is sent to all recipients. This provides one explanation for why prior art systems cannot inform an email sender which particular recipient(s) of a multiple recipient email opened the email.

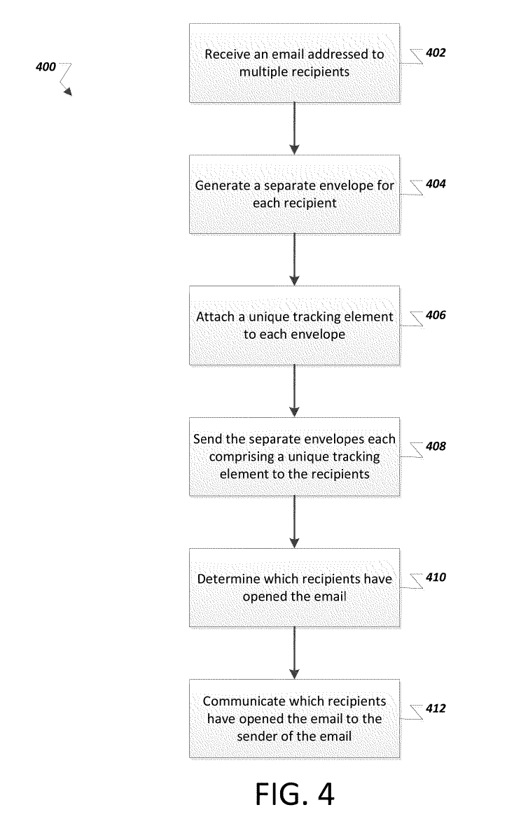

An aspect of the present disclosure provides an improvement over such prior art systems by creating a separate envelope containing a unique tracking element for each message recipient. In general, a tracking element can be made unique in any way that differentiates it from tracking elements embedded in other emails. For example, in some cases, a separate GUID may be embedded in each unique tracking element. In other cases, different types of media or different elements of the same type of media (e.g., two different images) may be used such that each tracking element is unique from other tracking elements. Such an approach allows the sender of an email to determine which particular recipient of a multiple recipient email opened the email. FIG. 4 is a flow chart showing an example method 400 for determining which recipient(s) opened an email sent to multiple recipients. In some instances, some or all steps of the method can be performed by sending server 106. In other instances, the method can be performed by other devices, for example, components of client device 104. The method can include receiving 402 an email addressed to multiple recipients. In some instances, the email can be received using SMTP protocol, or in some cases, other protocols. The method can include generating 404 a separate envelope for each recipient. One example technique for generating a separate envelope for each recipient is to generate a separate envelope for each RCPT command received (or similar command in other protocols). Such a technique may require manipulating the sending email client 136 such that it does not automatically repeat the RCPT command for each email recipient. It is illustrative to consider the example of an email addressed in the “To” line to bob@abc.com and joe@abc.com, and in the “cc” line to alice@ abc.com. After establishment of a connection between email client 136 and sending server 106, email client 136 can execute an RCPT command naming bob@ abc.com as a recipient of the email, which can occur either before or after email client 136 communicates the content of the email to sending server 106.

Before email client 136 executes another RCPT command, sending server 106 can create an envelope specific to bob@abc.com and, in some cases, can send the envelope to such address. In some implementations, a unique tracking element may be embedded in the envelope specific to bob@abc.com. After the envelope specific to bob@abc.com has been created, email client 136 can execute another RCPT command naming joe@abc.com as a recipient of the email, which can occur either before or after communication of the content of the email. Sending server 106 may then create another envelope specific to joe@abc.com and, in some cases, may send the envelope to such address. In some implementations, a unique tracking element different than the one embedded in the envelope specific to bob@abc.com can be embedded in the envelope specific to joe@abc.com. After the envelope specific to joe@abc.com has been created, email client 136 can execute another RCPT command naming alice@abc.com as a recipient of the email, which can occur either before or after communication of the content of the email. Sending server 106 may then create another envelope specific to alice@abc.com and, in some cases, may send the envelope to such address. In some implementations, a unique tracking element different than the one embedded in the envelope specific to bob@abc.com and joe@abc.com can be embedded in the envelope specific to alice@abc.com. The above process can be repeated for any number of recipients of a particular email. Further, the above description is only one example technique for creating a separate envelope for each recipient. Other techniques are also possible.

As discussed above, in some implementations, the method can include attaching 406 a unique tracking element to each envelope. The method can include sending 408 the separate envelopes each including a unique tracking element to each of the email recipients. In some instances, a particular envelope can be sent immediately after its creation and prior to the sending server's receipt of subsequent RCPT commands naming additional recipients. For example, in the example given above, the envelope specific to bob@abc.com may be sent prior to sending server 106 receiving an RCPT command naming joe@abc.com as a recipient. In other instances, the separate envelopes can be stored (e.g., in sending server memory 110) until an envelope for each recipient has been generated, at which time all envelopes can be sent concurrently. For example, in the example given above, the envelopes specific to bob@ abc.com and joe@abc.com may be stored until the envelope specific to alice@abc.com is generated, at which time all three envelopes can be sent concurrently. In such instances, after creation of each separate envelope, server system 106 may send a command indicating that the message has been queued.

An example exchange between sending email client 136 and sending server 106 according to one embodiment of the disclosure can be seen below. In this example exchange, a separate email envelope is created for each recipient of the email and all emails are queued such that they will be sent at the same time. As above, “C” represents “email client” and “S” represents “server.” The order in which information is communicated in the below example does not limit this disclosure. In general, information can be communicated between sending email client 136 and sending server 106 in any desired order.

C: RCPT TO: bob@abc.com

S: Ok

C: DATA

To: bob@abc.com; joe@abc.com

cc: alice@abc.com

Date: Tue, 8 Aug. 2014

Subject: Message

Hello Bob and Joe,

This is an example message.

Best,

Sender

<unique tracking element for bob>

.

S: Ok, queued

C: RCPT TO: joe@abc.com

S: Ok

C: DATA

To: bob@abc.com; joe@abc.com

cc: alice@abc.com

Date: Tue, 8 Aug. 2014

Subject: Message

Hello Bob and Joe,

This is an example message.

Best,

Sender

<unique tracking element for joe>

.

S: Ok, queued

C: RCPT TO: alice@abc.com

S: Ok

C: DATA

To: bob@abc.com; joe@abc.com

cc: alice@abc.com

Date: Tue, 8 Aug. 2014

Subject: Message

Hello Bob and Joe,

This is an example message.

Best,

Sender

<unique tracking element for alice>

.

S: Ok, queued

After the separate envelopes have been sent, the method can include determining 410 which recipients have opened the email. Such a determination can be made, for example, based upon which tracking element(s) establish a connection with sending server 106 (e.g., based on the unique GUID embedded in each tracking element). For example, in the example given above, if sending server 106 establishes a connection with the tracking element embedded in the envelope specific to bob@abc.com, but does not establish a connection with the tracking elements embedded in the envelopes specific to joe@abc.com or alice@abc.com, then sending server 106 can determine that bob@abc.com has opened the email, and joe@abc.com and alice@abc.com have not opened the email. Upon making this determination, the method can include communicating 412 which recipients have opened the email to the sender of the email. Such communication can, for example, be provided in the form of a notification displayed by sender's email client 136.

As mentioned above, in some implementations, in order for separate envelopes to be generated for each recipient, sender's email client 136 can be manipulated such that it does not automatically direct sending server 106 to send the email to all recipients listed in the email header (e.g., through repeated execution of the RCPT command). As a consequence of such manipulation, email client 136 can differentiate between recipients listed in the email header and recipients that will actually receive the email. Thus, in some instances, systems and methods of the present disclosure can be capable of sending an email to a recipient, where the email header lists certain recipients to which the email was not actually sent. An example situation in which such capabilities may be desired is if sender wants a recipient to think a particular individual was copied, but does not want to actually copy the particular individual. For example, imagine sender wants to send an email to bob@abc.com, and that sender wants bob@abc.com to think that joe@abc.com was copied, but that sender does not want to actually copy joe@abc.com. Because email client 136 of the present disclosure does not automatically execute an RCPT command for each recipient listed in the email header, in some implementations, it can provide sender with the option to not send the email to a recipient listed in the header. If sender elects such option, then, for example, email client 136 can instruct sending sever 106 to send the email to bob@abc.com (the content of such email including joe@abc.com listed in the email header), but can refrain from instructing sending server 106 to send the email to joe@abc.com (e.g., by not issuing a RCPT command for joe@abc.com).

In some implementations, certain methods discussed in this disclosure may be applied simultaneously. For example, an implementation of the present disclosure may employ the disclosed method for identifying specific recipients that open a multiple recipient email in conjunction with the disclosed method for determining the duration of time a particular email is open. In such an implementation, an email sender may be informed not only of which particular recipient(s) opened a multiple recipient email, but also the duration of time such recipient(s) had the email open. In addition, in some implementations, the disclosed method for determining whether to initiate or continue a connection with a tracking element (e.g., based on various aspects of recipient's environment) can be employed in conjunction with any other disclosed method(s).

### Operating Environment

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
sending an email containing a tracking element to a recipient;
establishing a connection with the tracking element upon the email being opened by the recipient;
determining a time when the connection ends; and
calculating a duration of the connection.

2. The computer-implemented method of claim 1 further comprising:
communicating the duration of the connection to a sender of the email.

3. The computer-implemented method of claim 1 further comprising:
embedding the tracking element within the email prior to sending the email to the recipient.

4. The computer-implemented method of claim 1 further comprising:
timing a length of the connection, wherein calculating a duration of the connection comprises referencing a result of the timing.

5. The computer-implemented method of claim 1 further comprising:
recording a time when the connection is opened, wherein calculating a duration of the connection comprises subtracting the time when the connection is opened from the time when the connection ends.

6. The computer-implemented method of claim 1 wherein the tracking element comprises at least one of an image, an audio element, and a video element.

7. A system comprising:
one or more data processing apparatus programmed to perform operations comprising:
sending an email containing a tracking element to a recipient;
establishing a connection with the tracking element upon the email being opened by the recipient;
determining a time when the connection ends; and
calculating a duration of the connection.

8. The system of claim 7 wherein the operations further comprise:
communicating the duration of the connection to a sender of the email.

9. The system of claim 7 wherein the operations further comprise:
embedding the tracking element within the email prior to sending the email to the recipient.

10. The system of claim 7 wherein the operations further comprise:
timing a length of the connection, wherein calculating a duration of the connection comprises referencing a result of the timing.

11. The system of claim 7 wherein the operations further comprise:
recording a time when the connection is opened, wherein calculating a duration of the connection comprises subtracting the time when the connection is opened from the time when the connection ends.

12. The system of claim 7 wherein the tracking element comprises at least one of an image, an audio element, and a video element.

13. A computer-implemented method comprising:
sending an email containing a tracking element to a recipient; and
detecting that an aspect of the recipient's environment may cause an undesirable side effect when used with the tracking element.

14. The computer-implemented method of claim 13 further comprising:
based on the detecting, determining to not initiate a connection with the tracking element.

15. The computer-implemented method of claim 13 further comprising:
aborting an existing connection with the tracking element.

16. The computer-implemented method of claim 13 wherein the aspect of the recipient's environment that may cause an undesirable side effect comprises at least one of an email client, a cellular data network, an email service provider, a mobile device, a computing device, and a software.

17. A system comprising:
one or more data processing apparatus programmed to perform operations comprising:
sending an email containing a tracking element to a recipient; and
detecting that an aspect of the recipient's environment may cause an undesirable side effect when used with the tracking element.

18. The system of claim 17 wherein the operations further comprise:
based on the detecting, determining to not initiate a connection with the tracking element.

19. The system of claim 17 wherein the operations further comprise:
aborting an existing connection with the tracking element.

20. The system of claim 17 wherein the aspect of the recipient's environment that may cause an undesirable side effect comprises at least one of an email client, a cellular data network, an email service provider, a mobile device, a computing device, and a software.

21. A computer-implemented method comprising:
receiving an email addressed to multiple recipients;
generating a separate envelope for each recipient;
attaching a unique tracking element to each envelope; and
sending the separate envelopes each comprising a unique tracking element to the recipients.

22. The computer-implemented method of claim 21, further comprising:
determining which recipients have opened the email by establishing separate connections with the unique tracking elements; and
communicating which recipients have opened the email to a sender of the email.

23. The computer-implemented method of claim 21, wherein the tracking element comprises at least one of an image, an audio element, and a video element.

24. A system comprising:
one or more data processing apparatus programmed to perform operations comprising:
receiving an email addressed to multiple recipients;
generating a separate envelope for each recipient;
attaching a unique tracking element to each envelope; and
sending the separate envelopes each comprising a unique tracking element to the recipients.

25. The system of claim 24 wherein the operations further comprise:
determining which recipients have opened the email by establishing separate connections with the unique tracking elements; and
communicating which recipients have opened the email to a sender of the email.

26. The system of claim 24 wherein the tracking element comprises at least one of an image, an audio element, and a video element.
